(19) United States
(12) Patent Application Publication
(10) Pub. No.: US 2015/0246288 A1
(43) Pub. Date: Sep. 3, 2015

(54) Systems and Methods for Data Processing for Games

(71) Applicant: Tencent Technology (Shenzhen) Company Limited, Shenzhen (CN)

(72) Inventor: Da Ma, Shenzhen (CN)

(21) Appl. No.: 14/708,865

(22) Filed: May 11, 2015

Related U.S. Application Data
(63) Continuation of application No. PCT/CN2014/082981, filed on Jul. 25, 2014.

(30) Foreign Application Priority Data
Dec. 16, 2013 (CN) 201310694976.9

(51) Int. Cl. A63F 13/71; A63F 13/35; A63F 13/77; G06F 17/30

(52) U.S. Cl. CPC A63F 13/71; G06F 17/30864; A63F 13/35; A63F 13/77

(57) ABSTRACT

Systems and methods are provided for online gaming. For example, an application-participation request is received from a user before a game is released; an application-participation process of the game is entered; an application-participation record of the user is saved; and the application-participation record is sent to the user when the game is released.

### CROSS-REFERENCES TO RELATED APPLICATIONS

The application claims priority to Chinese Patent Application No. 201310694976.9, filed Dec. 16, 2013, incorporated by reference herein for all purposes.

### BACKGROUND OF THE INVENTION

Certain embodiments of the present invention are directed to computer technology. More particularly, some embodiments of the invention provide systems and methods for data processing. Merely by way of example, some embodiments of the invention have been applied to games. But it would be recognized that the invention has a much broader range of applicability.

A user usually participates in one or more applications when playing a game. For example, participation in prize drawing occurs after a user has created a character and the prize may be distributed to the corresponding character. The user may not participate in the prize drawing without a game character.

FIG. 1 is a simplified conventional diagram showing data processing for a conventional application-participation system. As shown in FIG. 1, a user enters a character page to send a prize drawing request. A character selection server checks whether the user has a game character. If the user does not have a character, then the user is notified that he/she does not have a character and thus cannot participate in the prize drawing. If the user does have a character, then information associated with the user's character is sent to a prize drawing server. The prize drawing server reduces the user's prize drawing eligibility and calculates a probability of winning. If the user's prize drawing eligibility has been reduced (i.e., ineligible for prize drawing) or if the user does not win a prize, then the user is notified that he/she is not eligible for prize drawing or does not win a prize. If the user wins a prize, then the prize drawing server sends a delivery request to a game server which then sends the prize to the user and prompts the user to accept the prize.

The above-noted conventional technology has some disadvantages. For example, as described above, in a conventional application-participation system, a user often can participate in prize drawing only when the user has created a game character. When a new game has not yet been released, prize drawing may be used to attract users to try the new game for marketing purposes. However, a user cannot create a new character before the new game is released and obviously the user cannot have a game character to participate in the prize drawing.

Hence it is highly desirable to improve the techniques for data processing for games.

### BRIEF SUMMARY OF THE INVENTION

According to one embodiment, a method is provided for provided for online gaming. For example, an application-participation request is received from a user before a game is released; an application-participation process of the game is entered; an application-participation record of the user is saved; and the application-participation record is sent to the user when the game is released.

According to another embodiment, a data-processing device for online gaming includes: a receiving unit configured to receive an application-participation request from a user before a game is released; an entering unit configured to enter an application-participation process of the game; a saving unit configured to save an application-participation record of the user; and a sending unit configured to send the application-participation record to the user when the game is released.

According to yet another embodiment, a non-transitory computer readable storage medium includes programming instructions for online gaming. The programming instructions are configured to cause one or more data processors to execute certain operations. For example, an application-participation request is received from a user before a game is released; an application-participation process of the game is entered; an application-participation record of the user is saved; and the application-participation record is sent to the user when the game is released.

For example, the devices and methods disclosed herein are configured to solve the problem that a user cannot participate in applications in a game before the release of the game so that the user may participate in the applications before the release of the game.

Depending upon embodiment, one or more benefits may be achieved. These benefits and various additional objects, features and advantages of the present invention can be fully appreciated with reference to the detailed description and accompanying drawings that follow.

### BRIEF DESCRIPTION OF THE DRAWINGS

FIG. 1 is a simplified conventional diagram showing data processing for a conventional application-participation system.

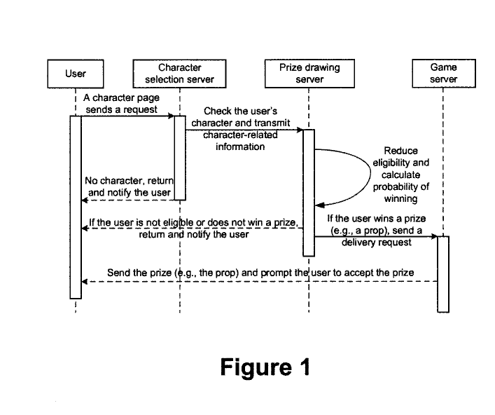

FIG. 2 is a simplified diagram showing data processing for an application participation system according to one embodiment of the present invention.

FIG. 3 is a simplified diagram showing a method for data processing for online games according to one embodiment of the present invention.

FIG. 4 is a simplified diagram showing a method for data processing for online games according to another embodiment of the present invention.

FIG. 5 is a simplified diagram showing a method for data processing for online games according to yet another embodiment of the present invention.

FIG. 6 is a simplified diagram showing a method for data processing for online games according to yet another embodiment of the present invention.

FIG. 7 is a simplified diagram showing application participation of a user and acquisition of application participation results according to one embodiment of the present invention.

FIG. 8 is a simplified diagram showing a device for data processing for online games according to one embodiment of the present invention.

FIG. 9 is a simplified diagram showing a device for data processing for online games according to another embodiment of the present invention.

FIG. 10 is a simplified diagram showing a device for data processing for online games according to yet another embodiment of the present invention.

FIG. 11 is a simplified diagram showing a device for data processing for online games according to yet another embodiment of the present invention.

### DETAILED DESCRIPTION OF THE INVENTION

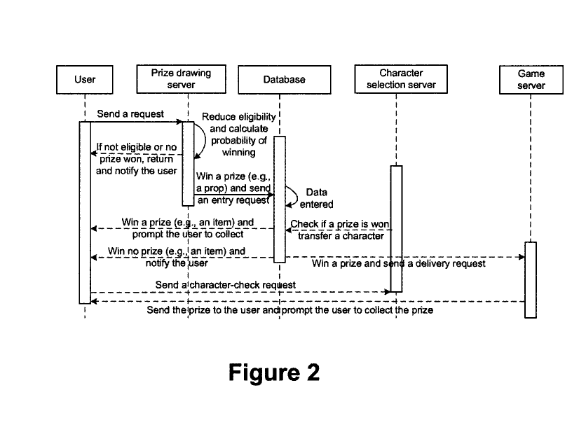

FIG. 2 is a simplified diagram showing data processing for an application participation system according to one embodiment of the present invention. The diagram is merely an example, which should not unduly limit the scope of the claims. One of ordinary skill in the art would recognize many variations, alternatives, and modifications.

Data processing related to application participation (e.g., in games) involves application participation and acquisition of results of the application participation, according to some embodiments. For example, application participation in a game includes participation in a prize drawing event, such as, prize drawing and prize collection. As an example, for prize drawing, a user may participate in the in-game application before the release date of the game when the user has not yet created a game character. As another example, if a user wins a prize in the prize drawing event, the user may obtain the prize from a game server after the release date of the game and then create a game character. As another example, after winning a prize, the user has exhausted his or her eligibility to draw a prize and cannot draw a prize again until he or she creates a game character. Thus, the user may draw a prize without a game character and obtain the prize after creating a game character based on the user's identification information used during the prize drawing (e.g., a QQ number, etc.), according to certain embodiments.

As shown in FIG. 2, during the prize drawing event, the user sends a prize drawing request to a prize drawing server for application participation in a game, according to some embodiments. For example, the prize drawing server receives the request sent by the user and verifies the user's eligibility for prize drawing. In another example, if the user is eligible for prize drawing, then the user is allowed to draw a prize and the user's eligibility is then reduced by the server in order to avoid repeated prize drawings. In yet another example, during the prize drawing event, the prize drawing server allocates a random probability to the user and determines whether such a random probability enables the user to win a prize.

According to one embodiment, if the user is not eligible for prize drawing or does not win a prize, the prize drawing server sends information to the user and notifies the user that he/she is not eligible for prize drawing or has not won a prize. For example, if the user wins a prize, the prize drawing server sends an entry request to a database so that the user's prize drawing information is recorded. In another example, to facilitate the management and the inquiry of prize drawing information of different users, the users may be categorized and stored based on information, such as last several digits of users' QQ numbers, when the users' prize drawing information is recorded in the database.

According to another embodiment, in response to the entry request, the users' prize drawing information is saved in the database. For example, the database saves a user's identification information (e.g., the user's QQ number), a name of the prize won, etc. In another example, if a user wins a prize, then the user is notified to redeem the prize. In yet another example, if a user has not won a prize, then the user is notified that he or she has not won a prize.

According to yet another embodiment, during the prize collection process, after the user enters the game, a character selection server prompts the user to choose a character and sends information regarding the character created by the user to the database. For example, the database locates the personal identification information of the current user and verifies whether he or she has won a prize. In another example, after the user's personal identification information and the prize information have been verified by the database, the game server is prompted to send the prize to this character. In yet another example, the game server sends the game to the user and prompts the user to enter the game and collect the prize.

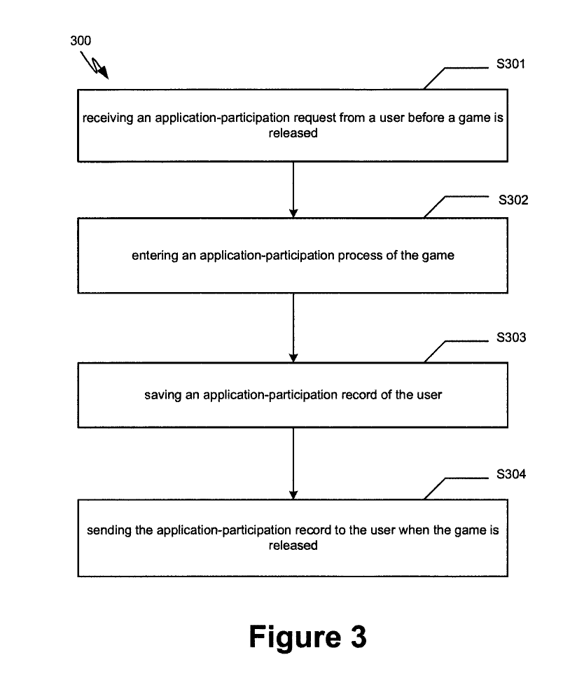

FIG. 3 is a simplified diagram showing a method for data processing for online games according to one embodiment of the present invention. The diagram is merely an example, which should not unduly limit the scope of the claims. One of ordinary skill in the art would recognize many variations, alternatives, and modifications. The method 300 includes at least processes S301-S304.

According to one embodiment, the process S301 includes: receiving an application-participation request from a user before a game is released. For example, before the game's release date, a game provider sets up a user prize drawing event and accepts user requests for participation in in-game applications in order to market the game. In another example, user requests for application participation can be received upon user clicks on a prize drawing icon. As an example, during the prize drawing event, the game provider may use game props or privileges as prizes. Users can draw predetermined prizes from a pool of prizes announced by the game provider. For example, users of QQ Sanguo may obtain character clothing, and users of Crossing the Fire Line may obtain items (e.g., weapons) as a prize.

According to another embodiment, the process S302 includes: entering an application-participation process of the game after receiving the application-participation request. For example, after the application-participation request has been received, the user is provided with information, such as prize drawing rules, chances of winning, prizes, etc., and is prompted to enter the application-participation process of the game. In another example, after entering the application-participation process, the user's eligibility for prize drawing is reduced in order to avoid repeated prize drawings and then whether the user has won a prize is determined In yet another example, if the user has won a prize, the game provider removes the prize from the pool of the prizes and notifies the user that he or she has won a prize. In yet another example, if the user has not won a prize, then a default prize is issued.

According to yet another embodiment, the process S303 includes: saving an application-participation record of the user. For example, after entering the application-participation process of the game, the user initiates the application-participation process and discovers the results of the prize drawing when the application-participation process is completed. In another example, the results of the prize drawing are saved in the database after the prize drawing has ended. In yet another example, the application participation record of the user includes winning a limited quantity of prizes issued by the game provider or obtaining the default prize issued by the game provider. As an example, the record of the user's application participation is first saved in a temporary table and then written into the database from the temporary table. Thus, accidental loss of the user's record that has not yet been saved in the database can be avoided, in some embodiments. For example, if the database does not receive the record of the user's application participation, it may query the temporary table again regarding the user's application participation to save the missing record of the user's application participation in the database. In another example, to facilitate saving the record of the user's application participation, the user's personal identification information can be categorized and saved in different partitions of the database. In yet another example, the last two digits of the user's QQ number can be used for categorization and the application participation of all users with QQ numbers ending with the same two digits can be saved in the same partition of the database.

In one embodiment, the process S304 includes: sending the application-participation record to the user when the game is released. For example, after the release date of the game, the record of the user's application participation is sent to the user and information regarding a prize which the user wins pops up in order to notify the user to redeem his or her prize. In another example, if the user has not won a prize, then the user is notified that he or she has exhausted his or her eligibility for prize drawing when he or she attempts to draw a prize again. In yet another example, the user can draw a prize before the release date of the game and is also able to obtain the prize after the release date of the game. Thus, the dependency of prize drawing on the creation of game characters can be avoided, not only enabling the user to enter the game application participation without creating a character, but also relieving the computational pressure of the server on the game release day, according to certain embodiments.

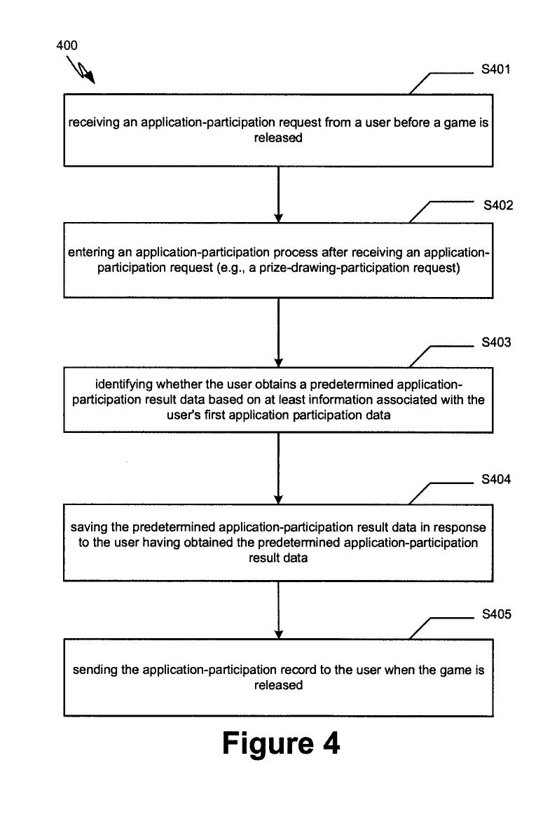

FIG. 4 is a simplified diagram showing a method for data processing for online games according to another embodiment of the present invention. The diagram is merely an example, which should not unduly limit the scope of the claims. One of ordinary skill in the art would recognize many variations, alternatives, and modifications. The method 400 includes at least processes S401-S405.

According to one embodiment, the process S401 includes: receiving an application-participation request from a user before a game is released. For example, before the game's release date, a game provider sets up a user prize drawing event and accepts user requests for participation in in-game applications in order to market the game. In another example, user requests for application participation can be received upon user clicks on a prize drawing icon. As an example, during the prize drawing event, the game provider may use game props or privileges as prizes. Users can draw predetermined prizes from a pool of prizes announced by the game provider. For example, users of QQ Sanguo may obtain character clothing, and users of Crossing the Fire Line may obtain items (e.g., weapons) as a prize.

According to another embodiment, the process S402 includes: entering an application-participation process of the game after receiving a prize-drawing-participation request. For example, after the application-participation request has been received, the user is provided with information, such as prize drawing rules, chances of winning, prizes, etc., and is prompted to enter the application-participation process of the game. In another example, after entering the application-participation process, the user's eligibility for prize drawing is reduced in order to avoid repeated prize drawings and then whether the user has won a prize is determined. In yet another example, if the user has won a prize, the game provider removes the prize from the pool of the prizes and notifies the user that he or she has won a prize. In yet another example, if the user has not won a prize, then a default prize is issued.

According to yet another embodiment, the process S403 includes: determining whether the user obtains predetermined application-participation result data based on at least information associated with first application-participation data of the user. For example, the first application participation data of the user is obtained and then compared with the predetermined application-participation result data. In another example, if the first application participation data is the same as the predetermined application-participation result data, then the user wins a prize. Otherwise, the user does not win a prize.

In one embodiment, the user can also receive a random probability sent by an application-participation system. For example, if the probability value reaches the predetermined probability, then the application-participation result is obtained. Otherwise, the application-participation result is not obtained. In another example, as far as the prize drawing is concerned, if the probability value reaches the predetermined probability, then the user wins a prize. Otherwise, the user does not win a prize.

In another embodiment, the process S404 includes: in response to the user obtaining the predetermined application-participation result data, saving the predetermined application-participation result data. For example, the application-participation result data includes prize data included in a prize package. In another example, the application-participation result data is saved in the database. After the release of the game, the saved application-participation result data is sent to a game server, and the game server issues a prize to the user, according to certain embodiments.

In yet another embodiment, the process S405 includes: sending the application-participation record to the user when the game is released. For example, after sending the record of the user's application participation to the user after the release date of the game, the user is notified of winning a prize and prompted to redeem the prize. If the user has not won a prize, then the user is notified that his or her eligibility for prize drawing has been exhausted when the user attempts to participate in the prize drawing again, according to certain embodiments.

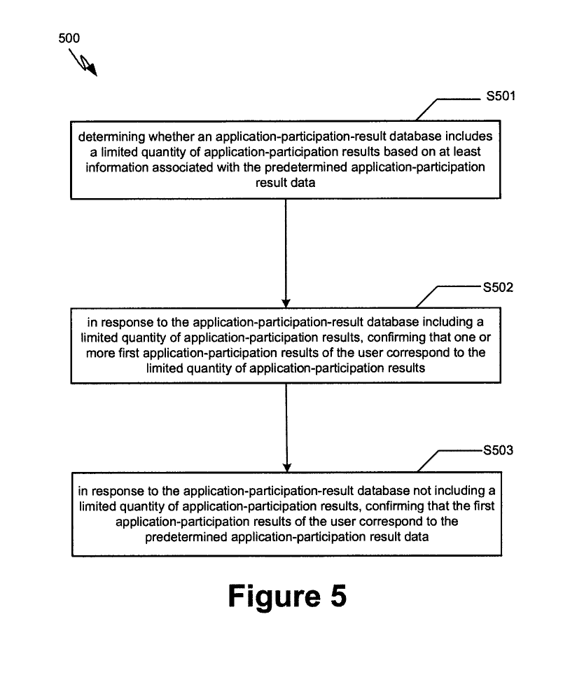

FIG. 5 is a simplified diagram showing a method for data processing for online games according to yet another embodiment of the present invention. The diagram is merely an example, which should not unduly limit the scope of the claims. One of ordinary skill in the art would recognize many variations, alternatives, and modifications. The method 500 includes at least processes S501-S503.

According to one embodiment, after a user has obtained a predetermined application-participation result data, the processes S501-S503 are executed. For example, the process S501 includes: determining whether an application-participation-result database includes a limited quantity of application-participation results based on at least information associated with the predetermined application-participation result data. Specifically, after the user's application-participation process has been completed, it is determined whether a limited quantity of application-participation results exist in the application-participation-result database based on the user's application-participation result data. As an example, if there are a limited quantity of application-participation results in the application-participation-result database, then the user may obtain the limited quantity of application-participation results. As another example, if there are not a limited quantity of application-participation results in the application-participation-result database, then the user may obtain default predetermined application-participation results.

According to another embodiment, the process S502 includes: in response to the application-participation-result database including a limited quantity of application-participation results, confirming that one or more first application-participation results of the user correspond to the limited quantity of application-participation results. For example, after it has been confirmed that the user's participation results are the limited quantity of application-participation results, the limited quantity of application-participation results are sent to the user. As an example, the process S503 includes: in response to the application-participation-result database not including a limited quantity of application-participation results, confirming that the first application-participation results of the user correspond to the predetermined application-participation result data. As another example, after it has been confirmed that the user's participation results are the default application-participation results, the default application-participation results are sent to the user.

According to yet another embodiment, the record of the user's application-participation is saved in the predetermined database in order for the user to collect the prize after the release date of the game. For example, the application-participation record is extracted from the database after the release date of the game and the application-participation record is sent to the user.

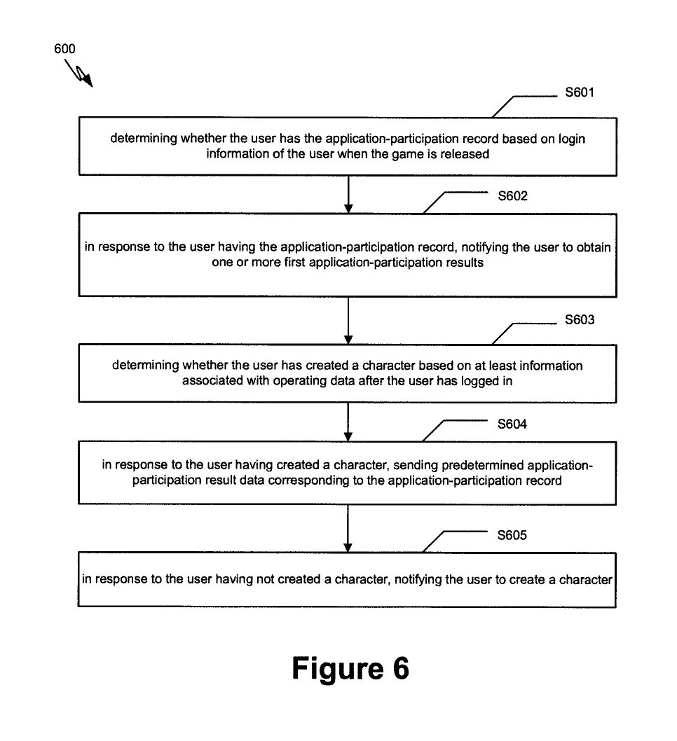

FIG. 6 is a simplified diagram showing a method for data processing for online games according to yet another embodiment of the present invention. The diagram is merely an example, which should not unduly limit the scope of the claims. One of ordinary skill in the art would recognize many variations, alternatives, and modifications. The method 600 includes at least processes S601-S605. For example, the method 600 corresponds to the process S304.

According to one embodiment, the process S601 includes: determining whether the user has the application-participation record based on login information of the user when the game is released. For example, after the release date of the game, the user's login information is received and information, such as a QQ number, can be used to identify the user. In another example, the user's login information and an application-participation record are saved in a database. In yet another example, after the release date of the game, the database determines whether the user has an application-participation record based on the user's login information. As an example, if it is determined that the user has an application-participation record, the user is notified to redeem the prize and create a game character. As another example, if it is determined that the user does not have an application-participation record, then a notification to redeem the prize is not sent.

According to another embodiment, the process S602 includes: in response to the user having the application-participation record, notifying the user to obtain one or more first application-participation results. For example, the user's application-participation record includes a limited quantity of application-participation results or default application-participation results. In another example, if the user has an application-participation record, then the user is notified to retrieve the limited quantity of application-participation results or the default application-participation results.

According to yet another embodiment, the process S603 includes: determining whether the user has created a character based on at least information associated with operating data after the user has logged in. For example, a character selection server determines whether the user has already created a character using the user's operating data after the user has logged in. As an example, if it is determined that the user has already created a character, the server prepares to send the application-participation results to the user and the user is prompted to create a character if he or she has not yet created a character.

In one embodiment, the process S604 includes: in response to the user having created a character, sending predetermined application-participation result data corresponding to the application-participation record. For example, after the character selection server has determined that the user has created a character, the character selection server sends a confirmation to the game server. The game server then sends the corresponding predetermined application-participation results to the user. In another embodiment, the process S605 includes: in response to the user having not created a character, notifying the user to create a character. For example, if the user has not yet created a character, then the character selection server prompts the user to create a character.

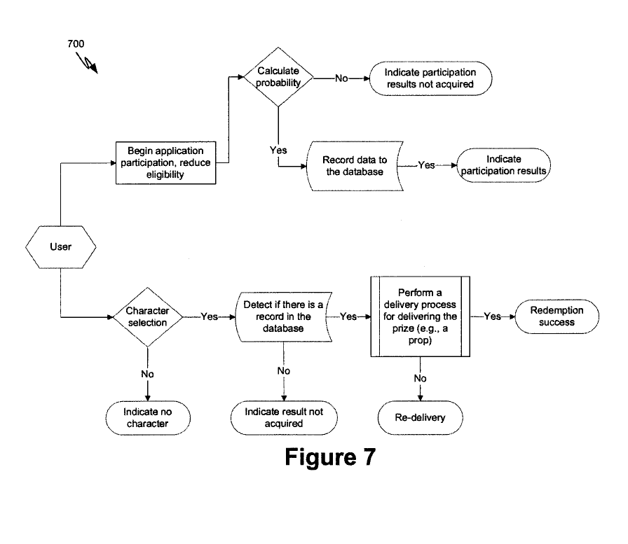

FIG. 7 is a simplified diagram showing application participation of a user and acquisition of application participation results according to one embodiment of the present invention. The diagram is merely an example, which should not unduly limit the scope of the claims. One of ordinary skill in the art would recognize many variations, alternatives, and modifications.

According to some embodiments, a user's participation in an in-game application and redemption of a prize are performed in two separate time periods respectively. For example, before the release date of the game, the user participates in a prize drawing event. In another example, after the release date of the game, if the user wins a prize, the user redeems the prize. In yet another example, before the release date of the game, the user enters the in-game application to participate in the activities of the game. As an example, the user may use a QQ number (e.g., 1234567) as his or her personal identification code to enter the prize drawing. Once the user begins participating in the prize drawing, the user's eligibility for the prize drawing is reduced and he or she cannot enter the prize drawing again. As another example, the number of times that a user can enter the prize drawing can be set by the system. For example, each user can draw a prize once or three times, which can be decided based on at least information associated with marketing needs and the predetermined quantity of the application-participation results. In another example, if the maximum number of opportunities for prize drawing is three, then the user cannot enter the prize drawing after the third time as his or her eligibility is exhausted.

According to one embodiment, when the user enters the prize drawing, he or she may preview the application-participation results, the limited quantity of application-participation results (e.g., exclusive gifts for QQ gaming members, props for game characters, etc.), and the default application-participation results (e.g., basic weapons for game characters, etc.). For example, by displaying the application-participation results to the user, the game provider can capture the user's attention and achieve the marketing goals for the game. In another example, when the user initiates the prize drawing, the application-participation system randomly sends the prize drawing information to the user. In yet another example, based on the prize drawing information that the user receives, the application-participation system then determines whether the user draws the application-participation results.

According to another embodiment, the user's participation results are divided into different levels that are determined based on the types of prizes. For example, the limited quantity of application-participation results correspond to one prize level and the default application-participation results correspond to another prize level. As an example, for the various levels of prizes, the application-participation system is configured based on data related to the expected number of users and the number of prizes that are expected to be issued. The method 700 can be applied regardless of the value set for the probability of a user winning a prize in the application-participation system, according to certain embodiments.

According to yet another embodiment, a user can find out whether he or she has won a prize after the prize drawing. For example, if a user does not win a prize, he or she is notified thereof by the application-participation system. In another example, if the user wins a prize, the application-participation system displays to the user the prize won and prompts him or her to redeem the prize after the release date of the game. As an example, after a user has won a prize, the application-participation system automatically reduces the user's eligibility for prize drawing, automatically calculates the user's remaining number of eligible participations in prize drawing and notifies the user thereof. As another example, if the user has exhausted his or her eligibility for prize drawing and still attempts to draw a prize, then the user is notified that he or she is no longer eligible to draw a prize. As yet another example, the user's QQ number can be used to determine whether the user's eligibility for prize drawing has been exhausted. In another example, after the user has drawn a prize, the remaining number of participations in prize drawing for the particular QQ number is recorded to avoid a situation where the same QQ number exceeds the predetermined number of participations in prize drawing.

In one embodiment, the application-participation system can automatically record the data regarding the prizes won by a user in the database. For example, during the recording process, the user's application participation data is first saved in a temporary table in order to avoid accidental errors when writing such data into the database. Then the data is saved in the database from the temporary table. As an example, if it is discovered that the user's application participation data is missing during the process of writing the data into the database, the system is set up to look for the application participation data of the specific user in the temporary table and then save it in the database. In another example, when saving the data, the database can be divided into different partitions in accordance with certain rules and one type of user application participation data can be saved in one partition. In yet another example, all of the users with QQ numbers ending in 01 may have their application participation data stored in the 01 partition of the database. Thus, when looking for a user's application participation data, the system may look for it directly in the 01 partition of the database, which is easier and more convenient to search for and can save memory resources, according to certain embodiments.

In another embodiment, after winning a prize, the user receives the information confirming that he or she has won. For example, the user is shown the prize and is prompted to redeem the prize after the release date of the game. As described above, the user participation of the in-game application is completed before the release of the game, and the prize drawing is conducted using QQ numbers or other information that can be used to identify a user, where relevant prize drawing information is recorded.

In yet another embodiment, the process of prize redemption is carried out after the release date of the game. For example, when a user enters the game, a gaming system (e.g., a game server) automatically detects whether the user has already registered a character. For example, if the user has registered a character, then the character is displayed and the user is notified to redeem the prize. In another example, if the user has not registered a character, then the character selection screen pops up to prompt the user to select a character. In yet another example, in QQ Sanguo, the user can select any of the following game characters: Jian Shi, Hao Jie, Yin Yan Shi, Shian Shu Shi, etc.

In yet another example, after the user has selected a character, the gaming system searches in the database based on the user's QQ number 1234567 to check whether an application-participation record exists for the particular user. For example, if an application-participation record exists in the database, an inquiry is made to check whether a prize corresponding to such an application-participation record has been issued. In another example, if a prize has been issued, then this application-participation record is marked as issued. If a prize has not been issued, then a request is made to issue the prize. In yet another example, if an application-participation record is not found in the database, then the user is notified that he or she has not won a prize.

According to one embodiment, after the user receives a reminder to redeem the prize, the user can confirm and redeem the prize. For example, the database first verifies the user's information and the prize information. After this has been verified with no errors, the gaming system is prompted to send the prize to the user and the gaming terminal confirms again whether the user has already redeemed the prize, in some embodiments. For example, a user creates his or her first character and collects the prize. Then the user deletes that character and creates a second character to redeem the prize again. The gaming terminal sends information to the game server to inform the user that the prize has already been issued. As an example, after the prize has been issued, the database makes a note of the corresponding user information and prize information to facilitate the management of the prize information. The game server can simultaneously receive multiple pieces of information regarding prize redemption and simultaneously issue multiple prizes of the same type to increase the efficiency of prize issuance, according to certain embodiments.

According to another embodiment, if, during the prize issuance process, the user's application-participation record is not found in the database, then the game server is sent information to re-issue the prizes and is prompted to re-issue the corresponding prizes to the user. For example, after the process has been completed, the prize can be successfully redeemed. Prize drawing before the game release and prize redemption after the game release can not only attract players before the release date of the game, but can also relieve the pressure on the server for the issuance of prizes after the release date of the game, according to some embodiments.

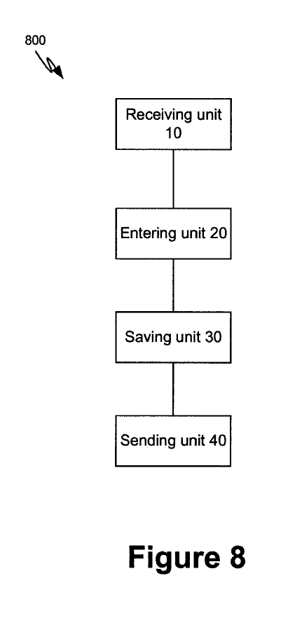

FIG. 8 is a simplified diagram showing a device for data processing for online games according to one embodiment of the present invention. The diagram is merely an example, which should not unduly limit the scope of the claims. One of ordinary skill in the art would recognize many variations, alternatives, and modifications. The data-processing device 800 includes a receiving unit 10, an entering unit 20, a saving unit 30, and a sending unit 40. For example, the device 800 is configured to execute the method 300.

According to one embodiment, the receiving unit 10 is configured to receive an application-participation request from a user before a game is released. For example, before the game's release date, a game provider sets up a user prize drawing event and accepts user requests for participation in in-game applications in order to market the game. In another example, user requests for application participation can be received upon user clicks on a prize drawing icon. As an example, during the prize drawing event, the game provider may use game props or privileges as prizes. Users can draw predetermined prizes from a pool of prizes announced by the game provider. For example, users of QQ Sanguo may obtain character clothing, and users of Crossing the Fire Line may obtain items (e.g., weapons) as a prize.

According to another embodiment, the entering unit 20 is configured to enter an application-participation process of the game upon the receipt of the application-participation request. For example, after the application-participation request has been received, the user is provided with information, such as prize drawing rules, chances of winning, prizes, etc., and is prompted to enter the application-participation process of the game. In another example, after entering the application-participation process, the user's eligibility for prize drawing is reduced in order to avoid repeated prize drawings and then whether the user has won a prize is determined. In yet another example, if the user has won a prize, the game provider removes the prize from the pool of the prizes and notifies the user that he or she has won a prize. In yet another example, if the user has not won a prize, then a default prize is issued.

According to yet another embodiment, the saving unit 30 is configured to save an application-participation record of the user. For example, after entering the application-participation process of the game, the user initiates the application-participation process and discovers the results of the prize drawing when the application-participation process is completed. In another example, the results of the prize drawing are saved in the database after the prize drawing has ended. In yet another example, the application participation record of the user includes winning a limited quantity of prizes issued by the game provider or obtaining the default prize issued by the game provider. As an example, the record of the user's application participation is first saved in a temporary table and then written into the database from the temporary table. Thus, accidental loss of the user's record that has not yet been saved in the database can be avoided, in some embodiments. For example, if the database does not receive the record of the user's application participation, it may query the temporary table again regarding the user's application participation to save the missing record of the user's application participation in the database. In another example, to facilitate saving the record of the user's application participation, the user's personal identification information can be categorized and saved in different partitions of the database. In yet another example, the last two digits of the user's QQ number can be used for categorization and the application participation of all users with QQ numbers ending with the same two digits can be saved in the same partition of the database.

According to yet another embodiment, the sending unit 40 is configured to send the application-participation record to the user when the game is released. For example, after the release date of the game, the record of the user's application participation is sent to the user and information regarding a prize which the user wins pops up in order to notify the user to redeem his or her prize. In another example, if the user has not won a prize, then the user is notified that he or she has exhausted his or her eligibility for prize drawing when he or she attempts to draw a prize again. In yet another example, the user can draw a prize before the release date of the game and is also able to obtain the prize after the release date of the game. Thus, the dependency of prize drawing on the creation of game characters can be avoided, not only enabling the user to enter the game application participation without creating a character, but also relieving the computational pressure of the server on the game release day, according to certain embodiments.

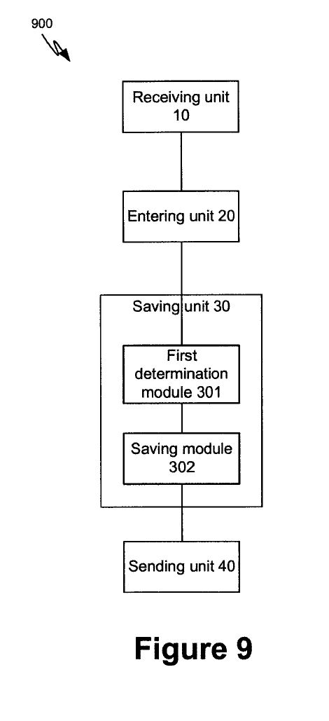

FIG. 9 is a simplified diagram showing a device for data processing for online games according to another embodiment of the present invention. The diagram is merely an example, which should not unduly limit the scope of the claims. One of ordinary skill in the art would recognize many variations, alternatives, and modifications. The data-processing device 900 includes a receiving unit 10, an entering unit 20, a saving unit 30, and a sending unit 40, where the saving unit 30 includes the first determination module 301 and a saving module 302. For example, the device 900 is configured to execute the method 300 and/or the method 400.

According to one embodiment, the receiving unit 10 is configured to receive an application-participation request from a user before a game is released. For example, before the game's release date, a game provider sets up a user prize drawing event and accepts user requests for participation in in-game applications in order to market the game. In another example, user requests for application participation can be received upon user clicks on a prize drawing icon. As an example, during the prize drawing event, the game provider may use game props or privileges as prizes. Users can draw predetermined prizes from a pool of prizes announced by the game provider. For example, users of QQ Sanguo may obtain character clothing, and users of Crossing the Fire Line may obtain items (e.g., weapons) as a prize.

According to another embodiment, the entering unit 20 is configured to enter an application-participation process of the game after receiving a prize-drawing-participation request. For example, after the application-participation request has been received, the user is provided with information, such as prize drawing rules, chances of winning, prizes, etc., and is prompted to enter the application-participation process of the game. In another example, after entering the application-participation process, the user's eligibility for prize drawing is reduced in order to avoid repeated prize drawings and then whether the user has won a prize is determined. In yet another example, if the user has won a prize, the game provider removes the prize from the pool of the prizes and notifies the user that he or she has won a prize. In yet another example, if the user has not won a prize, then a default prize is issued.

According to yet another embodiment, the saving unit 30 is configured to save an application-participation record of the user. For example, after entering the application-participation process of the game, the user initiates the application-participation process and discovers the results of the prize drawing when the application-participation process is completed. In another example, the results of the prize drawing are saved in the database after the prize drawing has ended. In yet another example, the application participation record of the user includes winning a limited quantity of prizes issued by the game provider or obtaining the default prize issued by the game provider. As an example, the record of the user's application participation is first saved in a temporary table and then written into the database from the temporary table. Thus, accidental loss of the user's record that has not yet been saved in the database can be avoided, in some embodiments. For example, if the database does not receive the record of the user's application participation, it may query the temporary table again regarding the user's application participation to save the missing record of the user's application participation in the database. In another example, to facilitate saving the record of the user's application participation, the user's personal identification information can be categorized and saved in different partitions of the database. In yet another example, the last two digits of the user's QQ number can be used for categorization and the application participation of all users with QQ numbers ending with the same two digits can be saved in the same partition of the database.

According to yet another embodiment, the sending unit 40 is configured to send the application-participation record to the user when the game is released. For example, after the release date of the game, the record of the user's application participation is sent to the user and information regarding a prize which the user wins pops up in order to notify the user to redeem his or her prize. In another example, if the user has not won a prize, then the user is notified that he or she has exhausted his or her eligibility for prize drawing when he or she attempts to draw a prize again.

In one embodiment, the first determination module 301 is configured to determine whether the user obtains predetermined application-participation result data based on at least information associated with first application-participation data of the user. For example, the first application participation data of the user is obtained and then compared with the predetermined application-participation result data. In another example, if the first application participation data is the same as the predetermined application-participation result data, then the user wins a prize. Otherwise, the user does not win a prize. As an example, the user can also receive a random probability sent by an application-participation system. For example, if the probability value reaches the predetermined probability, then the application-participation result is obtained. Otherwise, the application-participation result is not obtained. In another example, as far as the prize drawing is concerned, if the probability value reaches the predetermined probability, then the user wins a prize. Otherwise, the user does not win a prize.

In another embodiment, the saving module 302 is configured, in response to the user obtaining the predetermined application-participation result data, to save the predetermined application-participation result data. For example, the application-participation result data includes prize data included in a prize package. In another example, the application-participation result data is saved in the database. After the release of the game, the saved application-participation result data is sent to a game server, and the game server issues a prize to the user, according to certain embodiments.

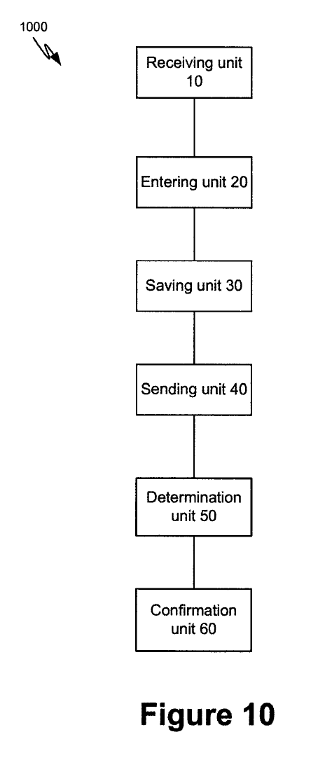

FIG. 10 is a simplified diagram showing a device for data processing for online games according to yet another embodiment of the present invention. The diagram is merely an example, which should not unduly limit the scope of the claims. One of ordinary skill in the art would recognize many variations, alternatives, and modifications. The data-processing device 1000 includes a receiving unit 10, an entering unit 20, a saving unit 30, a sending unit 40, a determination unit 50, and a confirmation unit 60. For example, the device 1000 is configured to perform the method 300, and/or the method 500.

According to one embodiment, the receiving unit 10 is configured to receive an application-participation request from a user before a game is released. For example, before the game's release date, a game provider sets up a user prize drawing event and accepts user requests for participation in in-game applications in order to market the game. In another example, user requests for application participation can be received upon user clicks on a prize drawing icon. As an example, during the prize drawing event, the game provider may use game props or privileges as prizes. Users can draw predetermined prizes from a pool of prizes announced by the game provider. For example, users of QQ Sanguo may obtain character clothing, and users of Crossing the Fire Line may obtain items (e.g., weapons) as a prize.

According to another embodiment, the entering unit 20 is configured to enter an application-participation process of the game upon the receipt of the application-participation request. For example, after the application-participation request has been received, the user is provided with information, such as prize drawing rules, chances of winning, prizes, etc., and is prompted to enter the application-participation process of the game. In another example, after entering the application-participation process, the user's eligibility for prize drawing is reduced in order to avoid repeated prize drawings and then whether the user has won a prize is determined. In yet another example, if the user has won a prize, the game provider removes the prize from the pool of the prizes and notifies the user that he or she has won a prize. In yet another example, if the user has not won a prize, then a default prize is issued.

According to yet another embodiment, the saving unit 30 is configured to save an application-participation record of the user. For example, after entering the application-participation process of the game, the user initiates the application-participation process and discovers the results of the prize drawing when the application-participation process is completed. In another example, the results of the prize drawing are saved in the database after the prize drawing has ended. In yet another example, the application participation record of the user includes winning a limited quantity of prizes issued by the game provider or obtaining the default prize issued by the game provider. As an example, the record of the user's application participation is first saved in a temporary table and then written into the database from the temporary table. Thus, accidental loss of the user's record that has not yet been saved in the database can be avoided, in some embodiments. For example, if the database does not receive the record of the user's application participation, it may query the temporary table again regarding the user's application participation to save the missing record of the user's application participation in the database. In another example, to facilitate saving the record of the user's application participation, the user's personal identification information can be categorized and saved in different partitions of the database. In yet another example, the last two digits of the user's QQ number can be used for categorization and the application participation of all users with QQ numbers ending with the same two digits can be saved in the same partition of the database.

According to yet another embodiment, the sending unit 40 is configured to send the application-participation record to the user when the game is released. For example, after the release date of the game, the record of the user's application participation is sent to the user and information regarding a prize which the user wins pops up in order to notify the user to redeem his or her prize. In another example, if the user has not won a prize, then the user is notified that he or she has exhausted his or her eligibility for prize drawing when he or she attempts to draw a prize again. In yet another example, the user can draw a prize before the release date of the game and is also able to obtain the prize after the release date of the game. Thus, the dependency of prize drawing on the creation of game characters can be avoided, not only enabling the user to enter the game application participation without creating a character, but also relieving the computational pressure of the server on the game release day, according to certain embodiments.

In one embodiment, the determination unit 50 is configured to determine whether an application-participation-result database includes a limited quantity of application-participation results based on at least information associated with the predetermined application-participation result data. Specifically, after the user's application-participation process has been completed, it is determined whether a limited quantity of application-participation results exist in the application-participation-result database based on the user's application-participation result data. As an example, if there are a limited quantity of application-participation results in the application-participation-result database, then the user may obtain the limited quantity of application-participation results. As another example, if there are not a limited quantity of application-participation results in the application-participation-result database, then the user may obtain default predetermined application-participation results.

In another embodiment, the confirmation unit 60 is configured, in response to the application-participation-result database including a limited quantity of application-participation results, to confirm that one or more first application-participation results of the user correspond to the limited quantity of application-participation results. For example, after it has been confirmed that the user's participation results are the limited quantity of application-participation results, the limited quantity of application-participation results are sent to the user. As an example, the confirmation unit 60 is further configured, in response to the application-participation-result database not including a limited quantity of application-participation results, to confirm that the first application-participation results of the user correspond to the predetermined application-participation result data. As another example, after it has been confirmed that the user's participation results are the default application-participation results, the default application-participation results are sent to the user.

According to yet another embodiment, the record of the user's application-participation is saved in the predetermined database in order for the user to collect the prize after the release date of the game. For example, the application-participation record is extracted from the database after the release date of the game and the application-participation record is sent to the user.

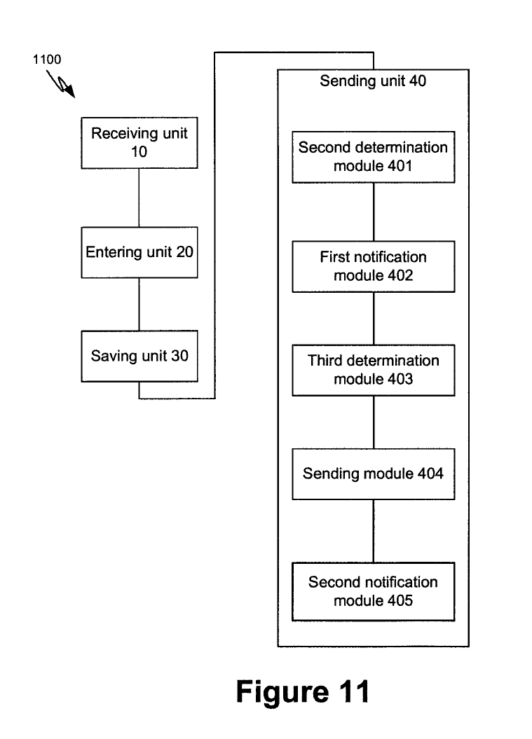

FIG. 11 is a simplified diagram showing a device for data processing for online games according to yet another embodiment of the present invention. The diagram is merely an example, which should not unduly limit the scope of the claims. One of ordinary skill in the art would recognize many variations, alternatives, and modifications. The data-processing device 1100 includes a receiving unit 10, an entering unit 20, a saving unit 30, and a sending unit 40, where the sending unit 40 includes a second determination module 401, a first notification module 402, a third determination module 403, a sending module 404, and a second notification module 405. For example, the device 1100 is configured to execute the method 300, and/or the method 600.

According to one embodiment, the receiving unit 10 is configured to receive an application-participation request from a user before a game is released. For example, before the game's release date, a game provider sets up a user prize drawing event and accepts user requests for participation in in-game applications in order to market the game. In another example, user requests for application participation can be received upon user clicks on a prize drawing icon. As an example, during the prize drawing event, the game provider may use game props or privileges as prizes. Users can draw predetermined prizes from a pool of prizes announced by the game provider. For example, users of QQ Sanguo may obtain character clothing, and users of Crossing the Fire Line may obtain items (e.g., weapons) as a prize.

According to another embodiment, the entering unit 20 is configured to enter an application-participation process of the game upon the receipt of the application-participation request. For example, after the application-participation request has been received, the user is provided with information, such as prize drawing rules, chances of winning, prizes, etc., and is prompted to enter the application-participation process of the game. In another example, after entering the application-participation process, the user's eligibility for prize drawing is reduced in order to avoid repeated prize drawings and then whether the user has won a prize is determined. In yet another example, if the user has won a prize, the game provider removes the prize from the pool of the prizes and notifies the user that he or she has won a prize. In yet another example, if the user has not won a prize, then a default prize is issued.

According to yet another embodiment, the saving unit 30 is configured to save an application-participation record of the user. For example, after entering the application-participation process of the game, the user initiates the application-participation process and discovers the results of the prize drawing when the application-participation process is completed. In another example, the results of the prize drawing are saved in the database after the prize drawing has ended. In yet another example, the application participation record of the user includes winning a limited quantity of prizes issued by the game provider or obtaining the default prize issued by the game provider. As an example, the record of the user's application participation is first saved in a temporary table and then written into the database from the temporary table. Thus, accidental loss of the user's record that has not yet been saved in the database can be avoided, in some embodiments. For example, if the database does not receive the record of the user's application participation, it may query the temporary table again regarding the user's application participation to save the missing record of the user's application participation in the database. In another example, to facilitate saving the record of the user's application participation, the user's personal identification information can be categorized and saved in different partitions of the database. In yet another example, the last two digits of the user's QQ number can be used for categorization and the application participation of all users with QQ numbers ending with the same two digits can be saved in the same partition of the database.

In one embodiment, the second determination module 401 is configured to determine whether the user has the application-participation record based on login information of the user when the game is released. For example, after the release date of the game, the user's login information is received and information, such as a QQ number, can be used to identify the user. In another example, the user's login information and an application-participation record are saved in a database. In yet another example, after the release date of the game, the database determines whether the user has an application-participation record based on the user's login information. As an example, if it is determined that the user has an application-participation record, the user is notified to redeem the prize and create a game character. As another example, if it is determined that the user does not have an application-participation record, then a notification to redeem the prize is not sent.

In another embodiment, the first notification module 402 is configured to notify, in response to the user having the application-participation record, the user to obtain one or more first application-participation results. For example, the user's application-participation record includes a limited quantity of application-participation results or default application-participation results. In another example, if the user has an application-participation record, then the user is notified to retrieve the limited quantity of application-participation results or the default application-participation results.

In yet another embodiment, the third determination module 403 is used to determine whether the user has created a character based on at least information associated with operating data after the user has logged in. For example, a character selection server determines whether the user has already created a character using the user's operating data after the user has logged in. As an example, if it is determined that the user has already created a character, the server prepares to send the application-participation results to the user and the user is prompted to create a character if he or she has not yet created a character.

In yet another embodiment, the sending module 404 is configured to send, in response to the user having created a character, predetermined application-participation result data corresponding to the application-participation record. For example, after the character selection server has determined that the user has created a character, the character selection server sends a confirmation to the game server. The game server then sends the corresponding predetermined application-participation results to the user. In yet another embodiment, the second notification module 405 is configured, in response to the user having not created a character, to notify the user to create a character. For example, if the user has not yet created a character, then the character selection server prompts the user to create a character.

According to one embodiment, a method is provided for provided for online gaming. For example, an application-participation request is received from a user before a game is released; an application-participation process of the game is entered; an application-participation record of the user is saved; and the application-participation record is sent to the user when the game is released. For example, the method is implemented according to at least FIG. 3.

According to another embodiment, a data-processing device for online gaming includes: a receiving unit configured to receive an application-participation request from a user before a game is released; an entering unit configured to enter an application-participation process of the game; a saving unit configured to save an application-participation record of the user; and a sending unit configured to send the application-participation record to the user when the game is released. For example, the device is implemented according to at least FIG. 8.

According to yet another embodiment, a non-transitory computer readable storage medium includes programming instructions for online gaming. The programming instructions are configured to cause one or more data processors to execute certain operations. For example, an application-participation request is received from a user before a game is released; an application-participation process of the game is entered; an application-participation record of the user is saved; and the application-participation record is sent to the user when the game is released. For example, the storage medium is implemented according to at least FIG. 3.

The above only describes several scenarios presented by this invention, and the description is relatively specific and detailed, yet it cannot therefore be understood as limiting the scope of this invention's patent. It should be noted that ordinary technicians in the field may also, without deviating from the invention's conceptual premises, make a number of variations and modifications, which are all within the scope of this invention. As a result, in terms of protection, the patent claims shall prevail.

For example, some or all components of various embodiments of the present invention each are, individually and/or in combination with at least another component, implemented using one or more software components, one or more hardware components, and/or one or more combinations of software and hardware components. In another example, some or all components of various embodiments of the present invention each are, individually and/or in combination with at least another component, implemented in one or more circuits, such as one or more analog circuits and/or one or more digital circuits. In yet another example, various embodiments and/or examples of the present invention can be combined.

Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform the methods and operations described herein. Other implementations may also be used, however, such as firmware or even appropriately designed hardware configured to perform the methods and systems described herein.

The systems' and methods' data (e.g., associations, mappings, data input, data output, intermediate data results, final data results, etc.) may be stored and implemented in one or more different types of computer-implemented data stores, such as different types of storage devices and programming constructs (e.g., RAM, ROM, Flash memory, flat files, databases, programming data structures, programming variables, IF-THEN (or similar type) statement constructs, etc.). It is noted that data structures describe formats for use in organizing and storing data in databases, programs, memory, or other computer-readable media for use by a computer program.

The systems and methods may be provided on many different types of computer-readable media including computer storage mechanisms (e.g., CD-ROM, diskette, RAM, flash memory, computer's hard drive, etc.) that contain instructions (e.g., software) for use in execution by a processor to perform the methods' operations and implement the systems described herein.

The computer components, software modules, functions, data stores and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code. The software components and/or functionality may be located on a single computer or distributed across multiple computers depending upon the situation at hand.

The computing system can include client devices and servers. A client device and server are generally remote from each other and typically interact through a communication network. The relationship of client device and server arises by virtue of computer programs running on the respective computers and having a client device-server relationship to each other.

This specification contains many specifics for particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations, one or more features from a combination can in some cases be removed from the combination, and a combination may, for example, be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Although specific embodiments of the present invention have been described, it is understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A data-processing method for online gaming, the method comprising:
receiving an application-participation request from a user before a game is released;
entering an application-participation process of the game;
saving an application-participation record of the user; and
sending the application-participation record to the user when the game is released.

2. The method of claim 1, wherein the saving an application-participation record of the user includes:
determining whether the user obtains predetermined application-participation result data based on at least information associated with first application-participation data of the user; and
in response to the user obtaining the predetermined application-participation result data, saving the predetermined application-participation result data.

3. The method of claim 2, further comprising:
determining whether an application-participation-result database includes a limited quantity of application-participation results based on at least information associated with the predetermined application-participation result data;
in response to the application-participation-result database including a limited quantity of application-participation results, confirming that one or more first application-participation results of the user correspond to the limited quantity of application-participation results; and
in response to the application-participation-result database not including a limited quantity of application-participation results, confirming that the first application-participation results of the user correspond to the predetermined application-participation result data.

4. The method of claim 1, wherein:
the saving an application-participation record of the user includes: saving the application-participation record of the user in a predetermined first database; and
the sending the application-participation record to the user when the game is released includes:
extracting the application-participation record of the user from the predetermined first database; and
sending the application-participation record of the user to the user.

5. The method of claim 1, wherein the sending the application-participation record of the user to the user:
determining whether the user has the application-participation record based on login information of the user when the game is released;
in response to the user having the application-participation record, notifying the user to obtain one or more first application-participation results;
determining whether the user has created a character based on at least information associated with operating data after the user has logged in;
in response to the user having created a character, sending predetermined application-participation result data corresponding to the application-participation record; and
in response to the user having not created a character, notifying the user to create a character.

6. A data-processing device for online gaming, the device comprising:
a receiving unit configured to receive an application-participation request from a user before a game is released;
an entering unit configured to enter an application-participation process of the game;
a saving unit configured to save an application-participation record of the user; and
a sending unit configured to send the application-participation record to the user when the game is released.

7. The device of claim 6, wherein the saving unit includes:
a first determination module configured to determine whether the user obtains predetermined application-participation result data based on at least information associated with first application-participation data of the user; and
a saving module configured to, in response to the user obtaining the predetermined application-participation result data, save the predetermined application-participation result data.

8. The device of claim 7, further comprising:
a determination unit configured to determine whether an application-participation-result database includes a limited quantity of application-participation results based on at least information associated with the predetermined application-participation result data; and
a confirmation unit configured to:
in response to the application-participation-result database including a limited quantity of application-participation results, confirm that one or more first application-participation results of the user correspond to the limited quantity of application-participation results; and
in response to the application-participation-result database not including a limited quantity of application-participation results, confirm that the first application-participation results of the user correspond to the predetermined application-participation result data.

9. The device of claim 6, wherein:
the saving unit is further configured to save the application-participation record of the user in a predetermined first database; and
the sending unit includes:
an extraction module configured to extract the application-participation record of the user from the predetermined first database; and
a sending module configured to send the application-participation record of the user to the user.

10. The device of claim 6, wherein the sending unit includes:
a second determination module configured to determine whether the user has the application-participation record based on login information of the user when the game is released;
a first notification module configured to, in response to the user having the application-participation record, notify the user to obtain one or more first application-participation results;
a third determination module configured to determine whether the user has created a character based on operating data after the user has logged in;
a sending module configured to, in response to the user having created a character, send predetermined application-participation result data corresponding to the application-participation record; and
a second notification module configured to, in response to the user having not created a character, notify the user to create a character.

11. The device of claim 6, further comprising:
one or more data processors; and
a computer-readable storage medium;
wherein the receiving unit, the entering unit, the saving unit and the sending unit are stored in the storage medium and configured to be executed by the one or more data processors.

12. A non-transitory computer readable storage medium comprising programming instructions for online gaming, the programming instructions configured to cause one or more data processors to execute operations comprising:
receiving an application-participation request from a user before a game is released;
entering an application-participation process of the game;
saving an application-participation record of the user; and
sending the application-participation record to the user when the game is released.
